(19) United States
(12) Patent Application Publication
(10) Pub. No.: US 2009/0178295 A1
(43) Pub. Date: Jul. 16, 2009

(54) APPARATUS AND METHODS FOR TREATING FABRICS IN A LAUNDRY DRYER

(75) Inventors: Mengtao Pete He, Phoenix, AZ (US); Michael Dreja, Neuss (DE); Pamela Lam, Scottsdale, AZ (US); Debra Park, Mesa, AZ (US)

Correspondence Address: SNELL & WILMER, LLP (Dial Corp), ONE ARIZONA CENTER, 400 E. VAN BUREN, PHOENIZ, AZ, 85004-2202, US

(73) Assignee: THE DIAL CORPORATION, Scottsdale, AZ (US)

(21) Appl. No.: 12/354,587

(22) Filed: Jan. 15, 2009

Related U.S. Application Data
(60) Provisional application No. 61/021,233, filed on Jan. 15, 2008.

(51) Int. Cl. F26B 7/00; F26B 19/00; F26B 21/06

(52) U.S. Cl. 34/380; 34/60; 34/526

(57) ABSTRACT

The present teachings provide apparatus and methods for reducing wrinkles in a laundered fabric. In various embodiments, the apparatus includes a dryer and a vapor generator device mounted within the dryer that dispenses a wrinkle reduction composition into the dryer upon a signal from a sensor in the dryer. Furthermore, the present teachings provide methods for delivering a wrinkle reduction composition into laundry dryer. In an exemplary embodiment, a method can include electronically monitoring at least one operating parameter of a laundry dryer to determine when the operating parameter meets a first preset condition, then activating a vapor generator when the first preset condition is met, and dispensing a vapor of a wrinkle reduction composition into the laundry dryer.

### CROSS-REFERENCE TO RELATED APPLICATIONS

This U.S. Non-Provisional Application claims priority to U.S. Provisional Application Ser. No. 61/021,233, entitled “APPARATUS AND METHODS FOR TREATING FABRICS IN A LAUNDRY DRYER,” filed Jan. 15, 2008 which is incorporated herein by reference.

### FIELD OF INVENTION

The present invention relates generally to laundry dryers and methods of drying laundry. More specifically, the present invention relates to apparatus and methods for treating fabrics being dried by a laundry dryer.

### BACKGROUND OF THE INVENTION

A conventional laundry dryer is generally an apparatus that dries laundry by forcibly blowing heated air onto washed laundry. Typically, much of the water has been removed from the washed laundry by a spin cycle in a conventional washing machine. One type of conventional laundry dryer is a drum-type laundry dryer, in which a large quantity of wet laundry is put into a rotating drum, and the wet laundry is dried while the laundry is rotated and tumbled.

In most cases, when the laundry is dried using the conventional drum-type laundry dryer, many wrinkles are formed, which causes an inconvenience, in that ironing has to follow the drying. Typically, the laundry dried by the drum-type laundry dryer has more wrinkles than laundry dried naturally, and therefore, it is difficult, as well as time consuming, to iron the dried laundry from the dryer. Furthermore, since the conventional drum-type laundry dryer is manufactured to dry a large quantity of laundry, sterilization of various kinds of harmful bacteria residing in the laundry, or deodorization of the laundry, may not occur. Additionally, the conventional drum-type laundry dryer can also cause static on to the laundry from the movement of different fabrics across each other during the tumbling. Further still, it is often desirable to soften or otherwise treat fabrics in laundry dryers. Improvements are needed for conventional laundry dryers.

### SUMMARY OF THE INVENTION

Accordingly, various embodiments of the present invention provide an apparatus for reducing wrinkles in a laundered fabric. In an exemplary embodiment, the apparatus includes a dryer and a vapor generator mounted within the dryer that dispenses a fabric treatment material such as a wrinkle reduction composition into the dryer. In this regard, though wrinkle reduction compositions are frequently used herein, it should be understood that other fabric treatment compositions such as softeners, anti-static, fragrance enhancers, fresheners, and others likewise fall within the scope of the present invention.

In addition, various embodiments of the present invention provide a system for use in the reduction of wrinkles in laundry. In an exemplary embodiment, the system can include a sensor that senses a condition of the laundry and sends a signal to an atomizer based on the condition and the atomizer then distributes a wrinkle reduction composition to the laundry on receipt of the signal. The system can optionally be self contained and can include a power supply operably coupled to the sensor and the atomizer. Moreover, various embodiments of the present invention include methods of reducing wrinkles in laundry that is being dried in a laundry dryer.

Further areas of applicability will become apparent from the detailed description provided herein. It should be understood that the detailed description and specific examples are intended for purposes of illustration only and are not intended to limit the scope of the present invention.

### BRIEF DESCRIPTION OF THE DRAWINGS

The drawings described herein are for illustration purposes only and are not intended to limit the scope of the present invention in any way. The present invention will become more fully understood from the detailed description and the accompanying drawings wherein:

FIG. 1 is a perspective view illustrating a wrinkle reduction device according to various embodiments of the present invention;

FIG. 2 is a fragmentary perspective view of FIG. 1 according to various embodiments of the present invention;

FIG. 3 is a perspective view of a wrinkle reduction apparatus according to various embodiments of the present invention;

FIG. 4 is an illustration of an example a method of reducing wrinkles in a dryer according to various embodiments of the present invention;

FIG. 5 is a flow chart illustrating an example of a method of monitoring an condition in a dryer according to various embodiments of the present invention;

FIG. 6 is a flow chart illustrating an example of a method of delivering multiple compositions into a dryer according to various embodiments of the present invention.

### DETAILED DESCRIPTION

The following description is merely exemplary in nature and is not intended to limit the present invention, applications, or uses. It should be understood that throughout the drawings, corresponding reference numerals indicate like or corresponding parts and features. The description of specific examples indicated in various embodiments of the present invention are intended for purposes of illustration only and are not intended to limit the scope of the invention disclosed herein. Moreover, recitation of multiple embodiments having stated features is not intended to exclude other embodiments having additional features or other embodiments incorporating different combinations of the stated features.

In various embodiments of the present invention, apparatus and methods monitor a condition in a laundry dryer and provide a fabric treatment composition to the laundry in the dryer when the condition is satisfied.

In an exemplary embodiment, the present invention provides a device for use in a laundry dryer. In this embodiment, the device includes a sensor that monitors a condition of laundry in the dryer and provides a signal based on the condition. In such an embodiment, the device includes a vapor generator that receives the signal and then delivers a fabric treatment composition from a reservoir onto the laundry.

In addition, the device can include a rigid body that contains at least two of a sensor, a vapor generator, a reservoir, and a power supply system, and can include an attachment device for attachment of the rigid body to an interior surface of a laundry dryer. In an exemplary embodiment, the device includes a power supply system coupled to the vapor generation device and the sensor, and the power supply can be a battery.

Furthermore, various embodiments of the present invention provide methods for delivering a fabric treatment composition such as a wrinkle reduction composition, to laundry. In an exemplary embodiment, a method includes electronically monitoring at least one operating parameter of a laundry dryer to determine when the operating parameter meets a first preset condition, then activating a vapor generator when the first preset condition is met, and dispensing a vapor of a wrinkle reduction composition into the laundry dryer.

In another exemplary embodiment, a method includes loading a fabric into a laundry dryer, drying the fabric in the laundry dryer, sensing a change in a condition in the laundry dryer, and signaling an actuator based on the change. In such an embodiment, the method includes actuating a vapor generator to dispense a vapor of a fabric treatment composition such as a wrinkle reduction composition into the dryer, and contacting the composition onto the fabric.

Moreover, in various embodiments, the present invention provides a device that can be positioned in a laundry dryer, which dispenses a composition that comprises water, a glycolic compound or other functional ingredients. In accordance with various aspects of the present embodiments, the dispensing of the composition can control the relative humidity within the laundry dryer which reduces or virtually eliminates the fabric wrinkle formation by controlling the amount and speed of moisture loss for the fabric materials during a laundry drying process.

In various embodiments, a fabric treatment composition used herein may also have anti-wrinkle characteristics when applied to a fabric in a laundry dryer during a drying cycle.

In addition, the composition can include adjunct ingredients like fragrance, anti-static actives, antibacterial materials, and softening ingredients can be delivered together with the wrinkle-reducing ingredient.

In various embodiments, the composition can include components that provide laundry care benefits of visual appearance and sensual feeling. Such components can include but are not limited to fabric softeners made of cationic polymers and other anti-static agents, and chemicals that prevent hair deposition on fabric can be applied as major or co-actives in the formulation of the composition.

In another exemplary embodiment, the composition can be incorporated in a spray system, and can be sprayed homogenously into the air held in a drum of a laundry dryer.

This sprayed composition can be deposited evenly on a fabric surface in the form of micro-particles that can have a size ranging between nanometer to multiple micrometers, such as for example from about 10⁻⁹ m to 10⁻⁴ m in particle sizes.

Still other exemplary embodiments provide a powered electrical device that can dispense a liquid or a solid material onto laundry during the laundry drying process essentially reducing or eliminating wrinkles formed in the laundry fabric materials. The device can be powered by battery or other power source and can be portable for easy placement in and removal from a laundry dryer. In another exemplary embodiment, the device can dispense the wrinkle reducing materials through a piezoelectric liquid or powder dispensing mechanism.

In addition, various embodiments of the present invention provide a system for use in the reduction of wrinkles in laundry. In an exemplary embodiment, the system can include a sensor that senses a condition of the laundry and sends a signal to an atomizer based on the condition and the atomizer then distributes a wrinkle reduction composition to the laundry on receipt of the signal. The system can be self contained and can include a power supply operably coupled to the sensor and the atomizer. Moreover, various embodiments of the present invention include methods of reducing wrinkles in laundry that is being dried in a laundry dryer.

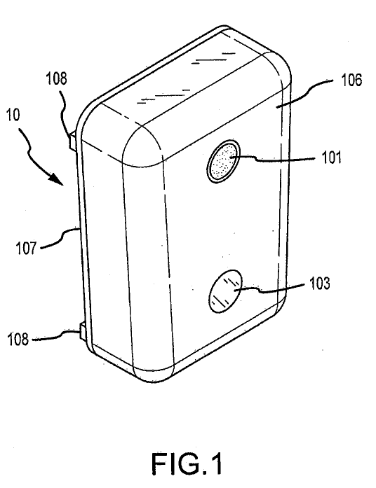

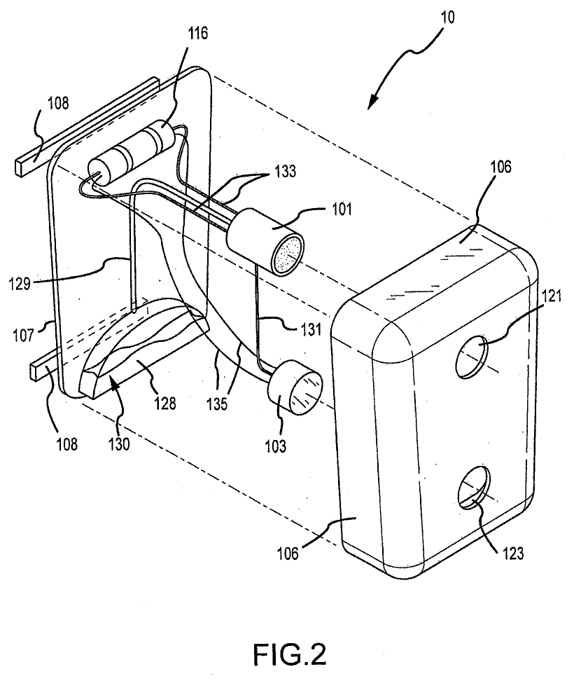

Turning to FIGS. 1 and 2, an exemplary monitoring and vapor generating device 10 for use in a laundry dryer is illustrated. In various embodiments, the device 10 comprises a vapor generator 101 and a sensor 103 that monitors at least one condition in the dryer. The device 10 can comprise a power supply 116 coupled by first electrical connector 133 to the vapor generator 101 and coupled by second electrical connector 135 to the sensor 103, all of which are enclosed by suitably rigid body components 106, 107.

Generally, the vapor generator 101 is a device that is capable of dispersing a composition 128 onto laundry in a laundry dryer. In various embodiments, the vapor generator 101 can disperse the composition 128 onto the laundry, as a liquid, as a powder, as a particulate, or combinations thereof. For example, in one embodiment, the vapor generator 101 atomizes the composition 128. In such an embodiment, the vapor generator 101 converts the composition 128 into a spray or a mist which can comprise droplets and/or particulates of the composition 128. In another embodiment, a solid material may be dissolved in composition 128 and the composition 128 may be applied to laundry by vapor generator 101. The composition 128 comprising dissolved powder can be atomized into small droplets which are retained on the laundry. As laundry dryer heats the droplets, they vaporize, leaving the powder on the laundry. The powder can comprise a fabric treatment composition such as a wrinkle reducing component.

In the previously described embodiments, the vapor generator 101 is in fluid communication with reservoir 130 by fluid passage 129. The fluid passage 129 provides a conduit for the composition 128 to be moved from the reservoir 130 to the vapor generator 101. The reservoir 130 is removably coupled to the fluid passage 129. In another aspect of this embodiment, the reservoir 130 is coupled to the fluid passage 129 by a connector (not shown). Examples of such connectors useful herein are well known to those skilled in the art and can include but are not limited to a quick connect, a Swagelok, a screw thread, a bayonet mount, a spring loaded coupling, or the like. When the reservoir 130 is empty, it can be removed from device 10 and replaced. In an aspect of this embodiment, the fluid passage 129 can comprise a wick that moves the composition 128 into the vapor generator 101. In another aspect of this embodiment, the fluid passage 129 includes a pump or a siphon system (not shown) that can draw the composition 128 from the reservoir 130 into the vapor generator 101. A further aspect of this exemplary embodiment can include the power supply 116 providing power for the pump or the siphon system of the fluid passage 129.

Examples of the vapor generator 101 include but are not limited to an atomizer, an electrostatic vapor generator, an ion generator, an ultrasonic generator, a powder dispensing device, a sprayer, an aerosol device, a piezoelectric device, and combinations thereof. Mechanisms that are useful herein for vapor generator 101 are known to those skilled in the art and examples of such may be easily modified, if that is even necessary, for use in device 10. Other examples known to those skilled in the art for use as a vapor generator 101 can include electrostatic vapor generators. In various embodiments, reservoir 130 is accessible to a user so that the user can remove the reservoir 130 and replace it with a new one. The replacement may include the uncoupling of a connector between fluid passage 129 and reservoir 130. In an aspect of such embodiments, the reservoir 130 contains the composition 128 which can be in the form of a gel, a liquid, a slurry, or a solid. The reservoir 130 can be pre-filled with the composition 128 or it can be refillable by the user from a container that holds a quantity of the composition 128. In an exemplary embodiment, multiple reservoirs can be provided, each containing a different formulation of the composition 128. In another exemplary embodiment as described herein, the reservoir 130 has multiple chambers and a valve system (not shown) to direct the fluid passage 131 to one of the multitude of chambers for fluid communication with the vapor generator 101. The use of multiple chambers in the reservoir 130 and a valve integrated between chambers is well known to those skilled in the art. The reservoir 130 can be made of any appropriate material such that the reservoir 130 is inert to composition 128 and preferably does not deform under the environmental conditions inside a laundry dryer during a drying cycle.

According to various embodiments, the device 10 includes a rigid body or housing that encases at least two of the vapor generator 101, the sensor 103, the power supply 116, and the reservoir 130 as illustrated in FIGS. 1 and 2. The housing can encase the vapor generator 101, the sensor 103, the power supply 116, and the reservoir 130. In an exemplary embodiment, the housing can comprise a front component 106 and a rear component 107 but housing is not limited to only such a configuration. As known to those skilled in the art, the housing can be designed and produced in any suitable configuration. For example, the housing may be designed to fulfill any of aesthetically pleasing, economically produced, ease of removal and replacement of the reservoir 130 and/or a battery in the power supply 116, to properly position the vapor generators 101 and/or sensor 103, for better attachment of the device 10 to the interior of the laundry dryer, and the like. As will be appreciated by those skilled in the art, the housing can be designed and produced in a single component, two components, or multiple components and is not limited to just the front component 106 and the rear component 107. The housing should withstand the heat, moisture and other stresses found in the interior of the laundry dryer during a drying cycle. The housing can be made of any appropriate material such that the housing does not deform or off gas under the environmental conditions inside a laundry dryer during a drying cycle.

Additionally with reference to FIG. 1, in various embodiments, the housing includes an attachment device 108 for attachment of the device 10 to an interior surface 154 of a laundry dryer 157. The attachment device 108 allows for removable attachment of the device 10 to an interior surface 154 of a laundry dryer 157. One of skill in the art will appreciate that although embodiments of the apparatus may be illustrated and described as being located within interior 156 and/or attached to laundry dryer 157, in various embodiments, portions of the apparatus such as the housing, a power source or other components may be located outside interior 156, and likewise may not necessarily be attached to laundry dryer 157. For example, components such as sensor 103, generator 101 (or just a dispensing portion of generator 101), or other components may be within laundry dryer 157, while others are external.

The attachment device 108 should withstand the heat, moisture and other stresses of the interior 156 of the laundry dryer 157 during a drying cycle. Examples of the attachment device 108 can include but are not limited to a magnet, bayonet clips, glue or other adhesives, extendable arms which may have a raw plug configuration. Other examples of the attachment device 108 can include a mounting bracket/frame for attachment to the interior surface 154 of the dryer door, to which the device 10 is then attached. In another example, the attachment device 108 can comprise a hook and loop system, such as for example, a Velcro® type system, having a portion of the hook and loop system on the device 10 and the other portion on the interior surface 154 of the dryer 157.

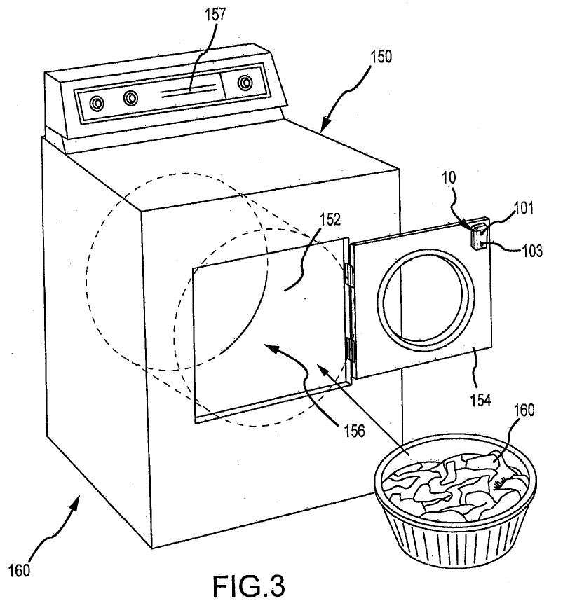

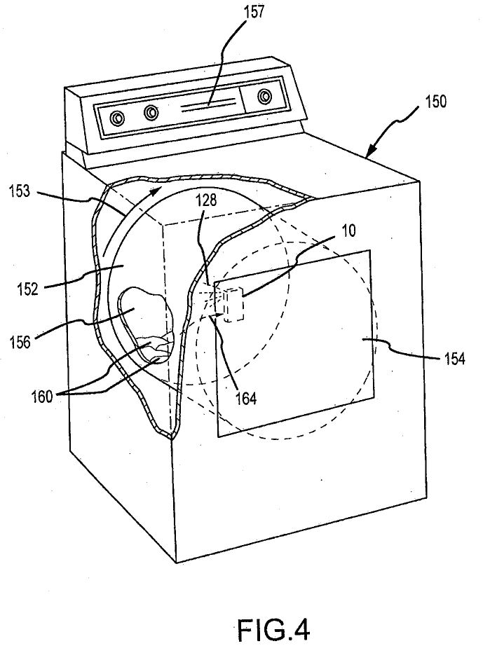

With reference to FIGS. 3 and 4, an apparatus 150 for reducing wrinkles in a laundered fabric is illustrated. In various embodiments, the apparatus includes an electrostatic vapor generator 101 mounted within a dryer 157 that dispenses a wrinkle reduction composition 128 into the dryer interior 157 and on to the laundry 160.

In various embodiments of the present invention provides a dryer system 150 for use in the reduction of wrinkles in laundry 160. In an exemplary embodiment, the system can include a sensor 103 that senses a condition 164 of the laundry 160 and sends a signal based on the condition 164. In this embodiment, the system includes a vapor generator 101 that distributes a fabric treatment composition 128 such as a wrinkle reduction composition to the laundry 160 on receipt of the signal, and can include a power supply 116 operably coupled to the sensor 103 and the vapor generator 101.

According to various embodiments of the present invention, a condition 164 can be any condition that can be measured by the sensor 103. Examples of the condition 164 can include but are not limited to humidity, static electric voltage, temperature, or time. In various embodiments, more than one condition 164 can be monitored by device 10 and as such, can be monitored by one or more sensors 103. The sensor 103 can be any sensor that can be used to monitor a condition 164 as described herein. Examples of the sensor 103 useful herein include but are not limited to a thermal couple, a relative humidity sensor, a clock, a timer, a voltage monitor, an electromagnetic sensor, an optical radiation sensor, a hall effect sensor, a resistance temperature detector, a transducer, combinations thereof and the like.

The sensor 103 can be coupled by second power connection 135 to the power supply 116 to provide sensor 103 with power as necessary to drive the sensor 103. Sensor 103 can be coupled by a signal connection 131 to the vapor generator 101. In an exemplary embodiment, the sensor 103 communicates via the signal connection 131 an On or an Off signal to vapor generator 101. For example, the sensor 103 is satisfied by the condition 164 thus sending an On signal to the vapor generator 101. As the composition 128 is dispersed into the dryer interior 156 by the vapor generator 101, the sensor 103 continues to monitor the condition 164. When the sensor 103 is no longer satisfied, the sensor 103 then sends an Off signal to the vapor generator 101 to stop the dispersing of the composition 128.

In an exemplary embodiment, the sensor 103 can be an array of the sensors 103 monitoring multiple conditions 164. For example, the sensor 103 may be an array which includes a relative humidity sensor, and a temperature sensor. In this example, the sensor 103 monitors relative humidity and temperature of the dryer interior 156. If the sensor 103 is satisfied for temperature, the sensor 103 sends an On signal via the signal connection 131 to the vapor generator 101 to disperse the composition 128. When the sensor 103 is no longer satisfied for temperature, the sensor 103 sends an Off signal to the vapor generator 101. During the same drying cycle, relative humidity may decrease below a certain level which encourages laundry to wrinkle. Further in this example, the sensor 103 is satisfied by a low relative humidity and sends an On signal via the signal connection 131 to the vapor generator 101 to disperse the composition 128. When the sensor 103 is no longer satisfied for low relative humidity, the sensor 103 sends an Off signal to the vapor generator 101. The composition 128 that is dispersed when the sensor 103 is satisfied for humidity may be the same formulation used for elevated temperature or may be a different formulation designed for controlling humidity in the dry interior 156.

In another exemplary embodiment, the sensor 103 may be an array of multiple sensors each communicating with the vapor generator 101 via the signal connection 131. In an aspect of this embodiment, the vapor generator 101 can also be in communication with a valve (not shown) located between the fluid passage 135 and the reservoir 130. In such example, the reservoir 130 may have multiple chambers each containing a different formulation of the composition 128 as described herein.

In still another exemplary embodiment, the sensor 103 may be an array that includes a humidity sensor, a temperature sensor, and a static sensor. For example, the humidity sensor 103 may be satisfied sending an On signal to the vapor generator 101 and a signal to the valve such that humidity formulation of the composition 128 may be dispersed by the vapor generator 101. Likewise, if the temperature sensor 103 is satisfied, the temperature sensor 103 sends an On signal to the vapor generator 101 and signal to the valve such that the vapor generator 106 can disperse a fragrance formulation of the composition 128 during a cool-down portion of dryer cycle. Still further, if the static sensor 103 is satisfied, the static sensor 103 sends an On signal to the vapor generator 101 and a signal to the valve such that the vapor generator 101 disperses anti-static formulation of the composition 128. It can be appreciated by one skilled in the art when any of the above sensors 103 in this example are no longer satisfied, the sensor 103 sends an Off signal to the vapor generator 101.

According to an exemplary embodiment, when any of the above sensors in this example are no longer satisfied, sensor 103 sends a signal to the valve sending it back to a home position. It will be appreciated by those skilled in the art that the sensor 103 and the signal connection 131 can include all the necessary electronics for operation, such as for example, control logic, electronic processors, timing devices, electronic triggers, switches, and other such processing means that may be useful in the implementation of device 10.

In various embodiments of the present invention, the device 10 can include mechanisms for user adjustments. For example the sensor 103 can include a knob, up or down buttons, a potentiometer, a toggle, or the like that can employed to adjust the sensitivity or to calibrate the sensor 103 by the user. In another example the vapor generator 101 can include a knob, up or down buttons, a potentiometer, a toggle, or the like that can employed to adjust the amount of the composition 128 that is dispensed on laundry 160.

In various embodiments, the power supply 116 is self-contained within the housing. The power supply 116 is coupled to the vapor generator 101 and may be coupled to the sensor 103 if the sensor 103 needs power. The power supply 116 can include a battery which may be changed by a user after the expiration of the life of the battery. In an aspect of these embodiments, the power supply 116 may be a thermoelectric conversion device that converts heat from the dryer interior 156 into power.

It will be appreciated by those skilled in the art that the power supply 116 includes all necessary electronics for operation, for instance, diodes, transistors, resistors, voltage converters, amplifiers and the like such that the power supply 116 can operate the vapor generator 101 and/or the sensor 103. In an aspect of these embodiments, the power supply 116 includes an On/Off switch which may be operated by a user.

In another aspect of these embodiments, the power supply 116 turns On by sensing increased heat, using for example, a temperature sensor monitoring the temperature from the dryer interior 156 and turns Off when the temperature lowers toward room temperature. In yet another aspect of these embodiments, the power supply 116 has a battery that lasts the lifetime of the device. For example, such a battery may be a nickel cadmium battery, lithium cadmium battery or any such battery known to those skilled in the art.

As noted above, the present invention provides a device 10 for use in a laundry dryer 157. In various embodiments, the device 10 includes a sensor 103 that monitors a condition 164 of laundry in the dryer 157 and provides a signal based on the condition 164. The device 10 can include a vapor generator 101 that receives the signal and delivers a fabric treatment composition 128 onto the laundry 160. The device 10 can include a power supply system 116 coupled to the vapor generator 101 and the sensor 103, and can include a reservoir 130 containing the fabric treatment composition 130 and in fluid communication with the vapor generator 101. In these embodiments, the device 10 can include a housing 107 which can contain any combination of the sensor 103, the vapor generator 101, the reservoir 128, and the power supply system 116. The device 10 can include an attachment device 108 for attachment of the housing to an interior surface 154 of the dryer 157.

In various embodiments, the composition 128 is a fabric treatment composition. The composition 128 may be in the form of a liquid, solid or gel. In an exemplary embodiment, the composition 128 comprises at least an anti-wrinkle component and optionally water. In another exemplary embodiment, the composition 128 comprises one or more perfume components so that the composition 128 can also act as a freshening composition.

In various embodiments, the composition 128 comprises an antistatic agent. Any suitable well-known antistatic agents used in laundering and dry cleaning art are suitable for use in the methods and compositions of the present invention. Examples of suitable antistatic agents can include a subset of fabric softeners which are known to provide antistatic benefits. However, it is to be understood that the term antistatic agent is not to be limited to just this subset of fabric softeners and includes all antistatic agents.

In various embodiments, the composition 128 comprises wrinkle reduction components. Any suitable well-known wrinkle reduction components used in laundering and dry cleaning art are suitable for use in the methods and compositions of the present invention. Examples of suitable wrinkle reduction components can include a subset of fabric softeners which are known to provide wrinkle reduction benefits. However, it is to be understood that the term wrinkle reduction component is not to be limited to just this subset of fabric softeners and includes all wrinkle reduction materials and agents.

In an exemplary embodiment, a wrinkle reduction component can be water or mixture of water with other components. For example, the wrinkle reduction component can be a glycolic compound such as, for example, glycerine, propylene glycol, any of the polyethyleneoxides, such as PEG 200 and PEG 400, any of the polypropyleneglycoles, any of the glycolethers, such as Dowanol, hydroxyl-group bearing solvents or liquid moisturizers, and combinations thereof. In another example, the wrinkle reduction component can be a silicon compound for example silicones, such as PDMS, aminosilicones, silicon quats, ethoxylated modified silicon compounds, and combinations thereof.

In yet another example, the wrinkle reduction component can be a cellulose material, for example modified cellulosic polymers, cationic celluloses, and combinations thereof. In still another example, the wrinkle reduction component can be a polymeric material, for example high molecular weight polyacrylamides, acrylics with PDMS, cross-linked polyvinyl alcohol (PVA), other cross-linked hydroxyl-containing polymers and combinations thereof. For example, the wrinkle reduction component can comprise at least one of a polyolefin, an aliphatic hydrocarbon, a sulfated vegetable oil, a sulfonated vegetable oil, a latex, an emulsion, and combinations thereof. In another example, the wrinkle reduction component can comprise one of a cellulose enzyme, an isomaltosuccinamide, an arabinogalactan, a natural cotyledon extract, and combinations thereof. In yet another exemplary embodiment, the wrinkle reduction material comprises a surface active material, for example a surfactant, a surface active polymer, an emulsifier and combinations thereof.

Other, nonlimiting examples of suitable wrinkle reduction components include an oxidised polyethylene, a sulfated castor oil, an ethoxylated silicones, an amino PDMS, polyacrylamides, an emulsion of high viscosity silicone oil and esterquat, silicone emulsions, triazine or pyrimidine units and a cross linking agent, cationic polyamide/epichlorhydrin resins, silicone lubricant compositions, non-ionic polyhydric alcohol, curable aminofunctionalized silicone, polyacrylate/dihydroxyethylurea and mixtures thereof.

In various embodiments, the composition 128 comprises suitable chemical ingredients that provide laundry care benefits of visual appearance and sensual feels. Examples of such chemical ingredients include but are not limited to fabric softeners made of cationic polymers and other anti-static agents, and chemicals that prevent hair deposition on fabric can be applied as major or co-actives in the composition 128 for added benefits.

In various embodiments, the composition 128 comprises suitable fabric care actives, such as, for example, the composition 128 can include, UV protection agents, dye transfer inhibiting agents and/or dye fixing agents, amino-containing softening agents, non-amino-containing softening agents, wrinkle reducing and/or removing agents, fabric rebuild agents, fiber repair agents, perfume release and/or delivery agents, shape retention agents, fabric and/or soil targeting agents, antibacterial agents, hygiene agents, irritant reducing agents, anti-discoloring agents, hydrophobic finishing agents and mixtures thereof.

In various embodiments, the composition 128 comprises a fragrance or a perfume. The fragrance or perfume can be applied to the laundry 160 as a deodorizer, a freshener, and/or scent of the user's choice. The fragrance, or perfume, may be any fragrant substance or mixture of substances, including natural and synthetic substances that have a favorable aroma.

In various embodiments, the composition 128 can be a charged liquid. In an exemplary embodiment, the composition 128 is a charged liquid and is dispersed by the vapor generator 101 that is operable as an electrostatic vapor generator. For example, the composition 128 is a charged liquid which can be useful in reducing or eliminating static in the laundry 160.

In various embodiments, the composition 128 comprises an antibacterial material. Antibacterial materials are well known to those skilled in the art and can include antimicrobials, antibiotics, septics, biosides, combinations thereof, or the like. Any appropriate material or agent that kills, reduces, suppresses, and/or inhibits germs, such as a strain of bacteria, in or on the laundry 160 can be used as a component in the composition 128. For example, antibacterial compounds useful herein include but are not limited to tetrasodium EDTA, alcohol compounds, triclosan, triclocbon, chlorine compounds, combinations thereof, or the like. In an aspect of these embodiments, the antibacterial material can be applied to the laundry 160 during a dryer 157 cool down portion of a drying cycle. In another aspect, the antibacterial material is applied at the beginning of the drying cycle so that the material is applied to the laundry 160 when it is cool and is eluted off after the laundry 160 has been heated.

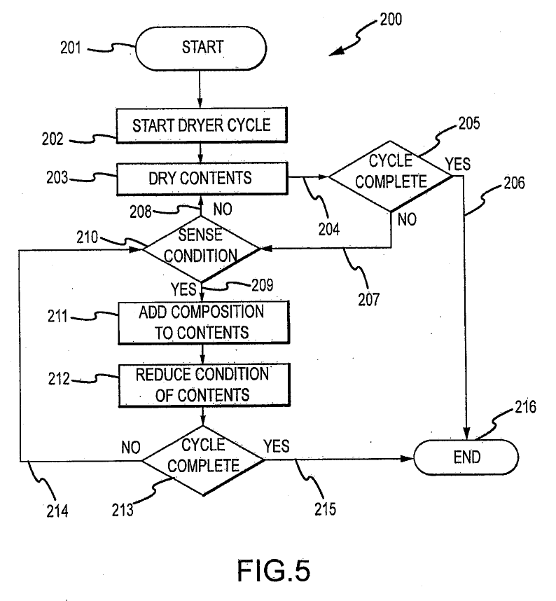

Now referencing FIG. 5, various embodiments of the present invention provide a method as illustrated by flow chart 200. At the start 201 of the flow chart 200, the method begins with start of the dryer cycle 202. The start of the dryer cycle 202 can include pushing a button to start a dryer or may include loading a dryer with laundry, selecting an appropriate drying cycle or program, and starting the selected drying cycle or program. Once the start dryer cycle 202 is completed, the next step is to dry contents 203. The contents can be anything that would be dried in a laundry dry, for example, laundry, clothing or clothes, fabrics, bedding, towels, shoes, and the like. After the dry contents 203, the flow 204 moves to the next step which is a decision point of cycle complete? 205. If the answer to cycle complete? 205 decision is YES then the flow 206 moves to the end 216 of the flow chart 200.

If the answer to cycle complete? 205 decision is NO, then the flow 207 moves to another decision point of sense condition 210. If the answer to sense condition 210 decision is NO, then the flow 208 moves to dry contents 203. If the answer to sense condition 210 is YES, then the flow 209 moves to add composition to contents 211. In various embodiments, the add composition to contents can be adding composition 128 to the contents in the dryer as discussed herein. The next step is reduce the condition of contents 212. In an exemplary embodiment, the condition 164 is reduced by the application of composition 128 onto the contents 160. The next step is a decision point of cycle complete? 213. If the answer to cycle complete? 213 decision is YES then the flow 215 moves to the end 216 of the flow chart 200. If the answer to cycle complete? 213 decision is NO, then the flow 214 moves back to the decision point of sense condition 210. In an exemplary embodiment, the device 10 is employed as part of a system for the implementation of the different steps and decision points of the flow chart 200. In another exemplary embodiment, the apparatus 150 is employed for the implementation of the different steps and decision points of the flow chart 200.

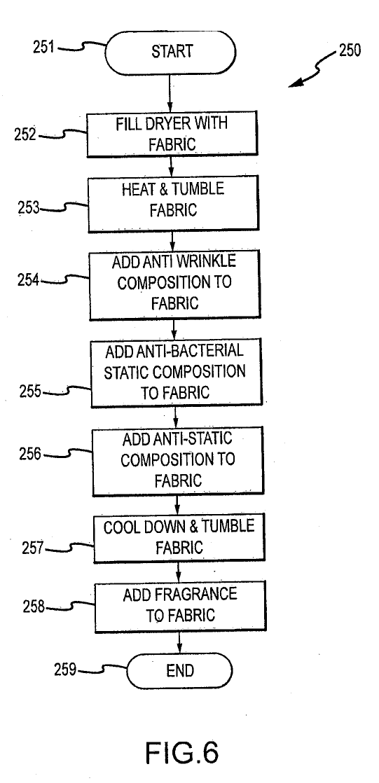

With reference now to FIG. 6, various embodiments of the present invention provide a method as illustrated by flow chart 250. At the start 251 of the flow chart 250, the first step is fill the dryer with fabric 252. The fabric can be for example the laundry 160 and the dryer 150 that is part of apparatus 150. The next step is heat and tumble fabric 253. The heat and tumble fabric 253 can include the use of a drying cycle or program as described herein. The next step is add anti wrinkle composition to fabric 254. The anti wrinkle composition can be the composition 128 as described herein. This step is followed by add antibacterial composition to fabric 255. The antibacterial composition can be a component of the composition 128 or can be a separate antibacterial material. The next step is add anti-static composition to fabric 256. The anti-static composition can be a component of composition 128 or can be a separate anti-static agent. This step is followed by cool down and tumble fabric 257. This step can be part of the drying cycle or program. During the cool down and tumble 257, typically heat is no longer applied to the fabric. This is followed by add fragrance to fabric 258. The fragrance can be a component of the composition 128 or can be a separate fragrance material. Since the fragrance is typically somewhat volatile, if heat is applied along with the fragrance, the fragrance has a tendency to end up going through the exhaust duct instead of being applied to the fabric. The last step is the end 259 of the flowchart 250. At the end 259 of the flowchart the fabric can be removed from the dryer. In an exemplary embodiment, the device 10 is employed as part of a system for the implementation of the different steps of the flow chart 250. In another exemplary embodiment, the apparatus 150 is employed for the implementation of the different steps of the flow chart 250.

Various embodiments of the present invention provide a method for reducing wrinkles in a fabric in a laundry dryer 157. The method can comprise the following steps: loading a fabric 160 into a laundry dryer 157; drying the fabric 160 in the laundry dryer 157; sensing a change in a condition 164 in the laundry dryer 157; signaling an actuator based on the change; actuating a vapor generator 101; dispensing a vapor of a wrinkle reduction composition 128 into the laundry dryer 157; contacting the wrinkle reduction composition 128 on the fabric 160; and reducing wrinkles in the fabric 160. In an aspect of these embodiments, the method further includes applying a fragrance, an antibacterial material, an anti-static agent, and/or a fabric conditioner to the fabric 160.

Various embodiments of the present invention provide a method for delivering a wrinkle reduction composition to laundry 160. The method can comprise electronically monitoring at least one operating parameter 164 of a clothes dryer 157 to determine when the operating parameter 164 meets a first preset condition, then activating a vapor generator 101 upon the first preset condition being met, thus dispensing a vapor of a wrinkle reduction composition 128 into a dryer interior 156. In an aspect of the embodiments, the method further comprises applying at least a portion of the wrinkle reduction composition 128 onto the laundry 160. The operating parameter 164 can be a temperature of the dryer interior 156, a humidity level of the dryer interior 156, and/or a time elapsed since beginning of a drying cycle. In another aspect of the embodiments, the method further comprises electronically monitoring the at least one operating parameter 164 of the clothes dryer 157 to determine when the at least one operating parameter meets a second preset condition and signaling the vapor generator 101 to stop dispensing the wrinkle reduction composition 128 into the dryer interior 156 once the second preset condition has been met.

In addition, according to various embodiments, the present invention provides a kit for the treatment of fabrics 160 in a laundry dryer cycle 157, comprising the combination of the device 10 together with the composition 128 which may be contained in the reservoir 130. Instructions for use of the device 10, including installation and/or refilling of the reservoir 130 may be included in the kit. An attachment device 108 may also be included in a kit. In an exemplary embodiment, the kit can include a coupon, for example the coupon may be redeemable for a free refill of composition 128 or a replacement reservoir 130 being filled with composition 128. The coupon may be redeemable for a discount on a refill of composition 128, for a replacement reservoir 130 being filled with composition 128, or for batteries useful in the power supply 116. The coupon may be redeemable for a free alternative formulation of the composition 128. In another exemplary embodiment, the kit can include a plurality of dryer sheets to be used in combination with the device. In an aspect of this exemplary embodiment, the dryer sheet comprises a chemical component that is activated by the composition that is dispensed by device 10.

Last, various embodiments and the examples described herein are exemplary and not intended to be limiting in describing the full scope of compositions and methods of these invention. Equivalent changes, modifications and variations of various embodiments, materials, compositions and methods can be made within the scope of the present invention, with substantially similar results.

What is claimed is:

1. An apparatus for reducing wrinkles in a laundry article, the apparatus comprising:
a dryer; and
a vapor generator mounted within said dryer and operable to dispense a non-volatile wrinkle reduction composition into said dryer.

2. The apparatus according to claim 1 wherein said vapor generator comprises at least one of an electrostatic vapor generator, an ion generator, an ultrasonic generator, a powder dispensing device, a sprayer, an aerosol device, and a piezoelectric device.

3. The apparatus according to claim 1, wherein said non-volatile wrinkle reduction composition comprises at least one of a gel, a liquid, a slurry, and a solid.

4. The apparatus according to claim 1, wherein said non-volatile wrinkle reduction composition comprises at least one of a fabric softener, a glycolic compound, a silicone compound, a cellulose material, a polymeric material, a cellulose enzyme, and a surface active material.

5. The apparatus according to claim 1, further comprising at least one of a temperature sensor and a humidity sensor mounted within said dryer and operably signaling said vapor generator to dispense said non-volatile wrinkle reduction composition into said dryer.

6. The apparatus according to claim 5, further comprising a timing device operably initiating said at least one of said sensor.

7. The apparatus according to claim 1, further comprising a timing device operably initiating said vapor generator to dispense said non-volatile wrinkle reduction composition into said dryer.

8. The apparatus according to claim 1, further comprising a power supply coupled to said vapor generator and at least one of a temperature sensor, a humidity sensor, and a timing device.

9. A system for use in the reduction of wrinkles in laundry, the system comprising:
a sensor operably sensing a condition of said laundry and sending a signal based on said condition;
an atomizer coupled to said sensor and operably distributing a non-volatile wrinkle reduction composition to the laundry on receipt of said signal; and
a power supply operably coupled to said sensor and said atomizer.

10. The system according to claim 9 wherein said atomizer comprises at least one of an electrostatic vapor generator, an ion generator, an ultrasonic generator, a powder dispensing device, a sprayer, an aerosol device, and a piezoelectric device.

11. The system according to claim 9, further comprising a dryer, said sensor and said atomizer being located within said dryer.

12. The system according to claim 9, further comprising a timer coupled to said power supply.

13. The system according to claim 9, further comprising a containment device having an interior volume, said sensor and said atomizer being in said interior volume and in communication with an environment surrounding said containment device.

14. The system according to claim 9, further comprising a reservoir holding said non-volatile wrinkle reduction composition and in fluid communication with said atomizer.

15. The system according to claim 9, further comprising a multi-chamber reservoir in fluid communication with said atomizer, wherein said multi-chamber reservoir comprises a first sub-chamber holding said non-volatile wrinkle reduction composition.

16. The system according to claim 9 wherein said condition comprises at least one of humidity, static electric voltage, temperature, and time.

17. A device for use in a laundry dryer, the device comprising:
a sensor operably monitoring a condition of laundry in said laundry dryer and providing a signal based on a level of said condition;
an atomizer receiving said signal and delivering a fabric care composition onto said laundry;
a power supply system coupled to and providing power to said atomizer and said sensor;
a reservoir containing said fabric care composition and in fluid communication with said atomizer;
a rigid body containing at least two of said sensor, said atomizer, said reservoir, and said power supply system; and
an attachment device for attachment of said rigid body to an interior surface of the laundry dryer.

18. The device according to claim 17 wherein said atomizer comprises at least one of an electrostatic vapor generator, an ion generator, an ultrasonic generator, a powder dispensing device, a sprayer, an aerosol device, and a piezoelectric device.

19. The device according to claim 18, further comprising a timer operably coupled to at least one of said atomizer, said power supply system, and said sensor.

20. The device according to claim 17, further comprising a connector between said reservoir and said atomizer, said connector operable for removably connecting said reservoir to said atomizer, said connector allowing fluid communication between said reservoir and said atomizer.

21. The device according to claim 17 wherein said sensor further provides an off signal to said atomizer based on an improved level of said condition.

22. The device according to claim 17 wherein said sensor comprises at least one of a humidity sensor, a temperature sensor, a voltage sensor, a thermal couple, a hall effect sensor, a transducer, and a resistance temperature detector.

23. The device according to claim 17, further comprising an on-off switch coupled to said power supply system.

24. The device according to claim 17 wherein said fabric care composition comprises a wrinkle reduction composition.

25. The device according to claim 24, wherein said wrinkle reduction composition comprises a non-volatile composition.

26. A method for delivering a wrinkle reduction composition to laundry, the method comprising:
electronically monitoring at least one operating parameter of a clothes dryer to determine when said at least one operating parameter meets a first preset condition;
responsive to said first preset condition being met, activating a vapor generator; and
dispensing a vapor of a non-volatile wrinkle reduction composition into said clothes dryer.

27. The method according to claim 26 wherein said operating parameter comprises at least one of a temperature inside said dryer, a humidity level inside said dryer, and a time elapsed since beginning of a drying cycle.

28. The method according to claim 26, further comprising:
electronically monitoring said at least one operating parameter of said clothes dryer to determine when said at least one operating parameter meets a second preset condition; and
responsive to said second preset condition being met, signaling said vapor generator to stop dispensing said non-volatile wrinkle reduction composition into said clothes dryer.

29. The method according to claim 26, further comprising applying at least a portion of said non-volatile wrinkle reduction composition onto the laundry.
